(19) United States
(12) Patent Application Publication
(10) Pub. No.: US 2025/0124129 A1
(43) Pub. Date: Apr. 17, 2025

(54) JUDGEMENT DEVICE, JUDGEMENT METHOD, AND JUDGEMENT PROGRAM

(71) Applicant: NIPPON TELEGRAPH AND TELEPHONE CORPORATION, Tokyo (JP)

(72) Inventors: Daiki CHIBA, Musashino-shi, Tokyo (JP); Toshiki SHIBAHARA, Musashino-shi, Tokyo (JP); Mitsuaki AKIYAMA, Musashino-shi, Tokyo (JP)

(73) Assignee: NIPPON TELEGRAPH AND TELEPHONE CORPORATION, Tokyo (JP)

(21) Appl. No.: 18/685,237

(22) PCT Filed: Sep. 28, 2021
(86) PCT No.: PCT/JP2021/035717

§ 371 Date: Feb. 21, 2024

(51) Int. Cl. G06F 21/56

(52) U.S. Cl. CPC G06F 21/566; G06F 2221/034

(57) ABSTRACT

A determination apparatus uses an identification model for identifying whether or not input data is malignant, to obtain a result of identifying whether or not the input data is malignant. Further, the determination apparatus obtains grounds (explanation result) for the identification of the input data in the identification model using an explanation model that outputs the grounds for the identification in the identification model. The determination apparatus obtains a probability that identification results of the identification model is incorrect using an objection determination model receiving a result of the identification and an identification explanation result, and outputting a probability that the identification result is incorrect. The determination apparatus extracts data to be verified by the user on the basis of the probability that the identification result is incorrect.

### TECHNICAL FIELD

The present invention relates to a determination apparatus, a determination method, and a determination program.

### BACKGROUND ART

In the related art, there are technologies for detecting malicious activity in a cyberspace using a machine-learned model. However, model detection is not perfect and may result in false detection or overlooking of malicious activity. For this reason, it is essential for humans to verify detection results of the model in a practical scene.

As a scheme of assisting the above human verification, there is a method of using explainable AI (XAI) that outputs grounds of the detection result of the model. It is possible to verify the detection results of the above model by a human confirming output results of this XAI.

### CITATION LIST

### Non Patent Literature

[NPL 1] S. C. Sundaramurthy, et al., A Human Capital Model for Mitigating Security Analyst Burnout, Proc. SOUPS, 2015.

[NPL 2] Ponemon Institute, Improving the Effectiveness of the Security Operations Center, 2019.

[NPL 3] D. Chiba, et al., Domain Profiler: Discovering Domain Names Abused in Future, in Proc. IEEE/IFIP DSN, 2016.

[NPL 4] N. Fukushi, et al., Exploration into Gray Area: Toward Efficient Labeling for Detecting Malicious Domain Names, IEICE Trans. Communications, 2020.

[NPL 5] Adadi, et al., Peeking Inside the Black-Box: A Survey on Explainable Artificial Intelligence (XAI), IEEE Access, 2018.

[NPL 6] Ministry of Internal Affairs and Communications, AI Network Society Promotion Council Report 2018, [Retrieved on Sep. 22, 2021], Internet <URL:http://www.soumu.go.jp/menu news/s-news/01iicp01_02000072.html>

[NPL 7] Ribeiro, et al., “Why Should I Trust You?” Explaining the Predictions of Any Classifier, Proc. ACM KDD, 2016.

[NPL 8] Lundberg, et al., A Unified Approach to Interpreting Model Predictions, Proc. NIPS, 2017.

[NPL 9] I. Lage, et al., Human-in-the-Loop Interpretability Prior, Proc. NeurIPS, 2018.

### SUMMARY OF INVENTION

### Technical Problem

However, when the number of detection results that is a verification target is enormous, it is difficult for humans to confirm all the grounds of the detection results (XAI output results). It can also be difficult to interpret the output results of XAI. Accordingly, an object of the present invention is to reduce the labor required for a person to verify detection results of a model.

### Solution to Problem

In order to solve the above-described problem, a determination apparatus includes an identification unit configured to identify whether or not input data is malignant using an identification model for identifying whether or not the input data is malignant; a grounds output unit configured to output grounds for identification of the input data in the identification model using an explanation model for outputting grounds for identification using the identification model; and a determination unit configured to input a result of the identification and the grounds for the identification to an objection determination model, the objection determination model receiving the result of the identification and the grounds for the identification and outputting a probability that the result of the identification is incorrect, to output the probability that the result of the identification is incorrect.

### ADVANTAGEOUS EFFECTS OF INVENTION

According to the present invention, it is possible to reduce labor when a human verifies the detection result of the model.

### BRIEF DESCRIPTION OF DRAWINGS

FIG. 1 is a diagram illustrating an overview of a determination apparatus,

FIG. 2 is a diagram illustrating a configuration example of the determination apparatus.

FIG. 3 is a diagram illustrating an example of creation of a training data set for an objection determination model.

FIG. 4 is a flowchart illustrating an example of a learning procedure of an objection determination model in a first embodiment.

FIG. 5 is a flowchart illustrating an example of determination processing using an objection determination model in the first embodiment.

FIG. 6 is a flowchart illustrating an example of a learning procedure of an objection determination model in a second embodiment.

FIG. 7 is a diagram illustrating a configuration example of a computer that executes a determination program.

### DESCRIPTION OF EMBODIMENTS

Hereinafter, modes (embodiments) for carrying out the present invention will be divided into a first embodiment and a second embodiment and described with reference to the drawings. The present invention is not limited to each embodiment.

### First Embodiment

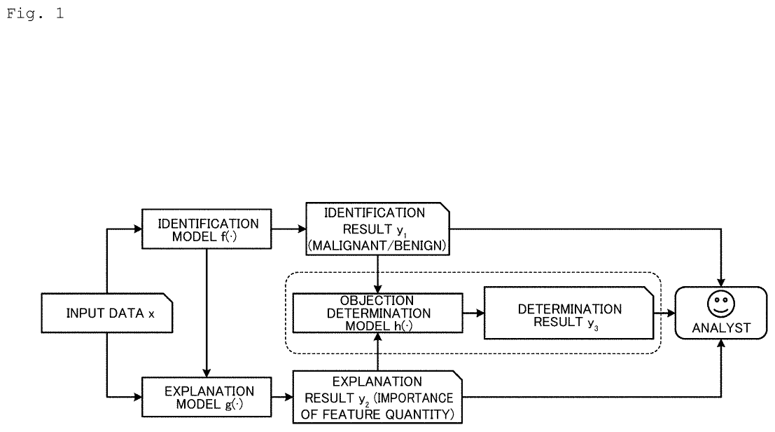

First, an overview of a determination apparatus of a first embodiment will be described with reference to FIG. 1. The determination apparatus includes an identification model, an explanation model, and an objection determination model.

The identification model is a model that outputs an identification result as to whether or not input data is malignant. For example, the identification model outputs the probability that input data is malignant as an identification result.

Also, the explanation model is a model that outputs grounds for identification by the identification model. For example, when the explanation model receives the input of the identification model and the input data to the identification model, the explanation model outputs the grounds of the identification by the identification model (explanation result). This explanation result is, for example, information indicating the importance of each feature quantity used by the identification model.

The objection determination model is a model that takes as an input the identification result of the input data from the identification model and the explanation result from the explanation model, and outputs a value indicating the plausibility of the identification result of the input data (for example, the probability that the identification result is incorrect) as the determination result.

This objection determination model is learned on the basis of the identification result of the identification model, the explanation result of the explanation model, and a label indicating whether or not the identification result is correct (a label indicating a true value).

A user (for example, an analyst) of the determination apparatus can ascertain the plausibility of the identification result of the input data from the identification model by confirming the determination result output by the objection determination model.

Thereby, the user of the determination apparatus can, for example, ascertain an identification result that is highly likely to be erroneous among the identification results of the input data. Therefore, for example, since the user can ascertain which identification result should be preferentially verified, the identification result can be verified efficiently. For example, the user can reduce the labor required for verification by narrowing down identification results that are highly likely to be incorrect and performing verification.

### Configuration

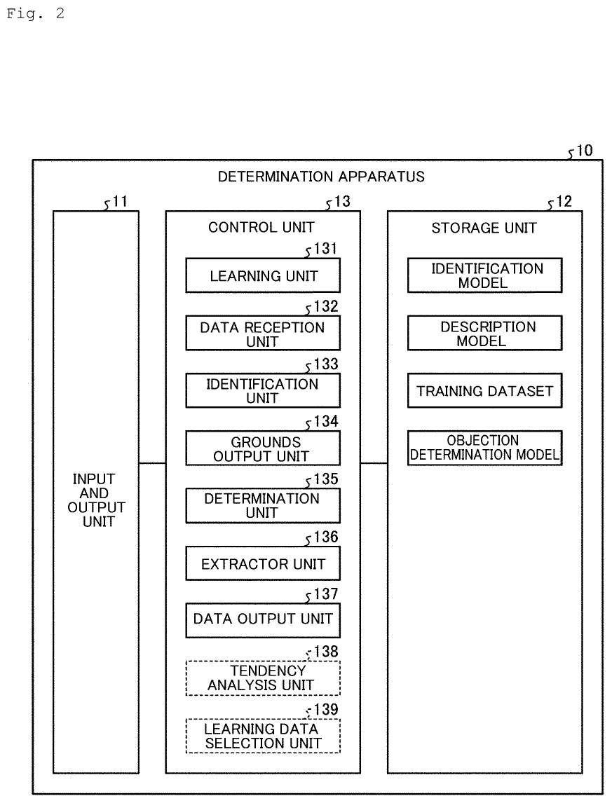

Next, a configuration example of the determination apparatus 10 will be described with reference to FIG. 2. The determination apparatus 10 includes an input and output unit 11, a storage unit 12 and a control unit 13.

The input and output unit 11 is an input and output interface that receives input of various types of data used by the control unit 13 and outputs results of processing of the control unit 13.

The storage unit 12 is a storage device such as a hard disk drive (HDD), a solid state drive (SSD), an optical disc, or the like. The storage unit 12 may be a semiconductor memory such as a random access memory (RAM), a flash memory, or the like in which data can be rewritten. The storage unit 12 stores an operating system (OS) or various programs executed by the determination apparatus 10. Further, the storage unit 12 stores various types of information used in executing the program.

For example, the storage unit 12 stores the identification model, the explanatory model, a data set used for learning the identification model, and the like. Further, when the objection determination model is learned by the control unit 13, the objection determination model is stored in the storage unit 12.

As described above, the identification model is a model that outputs an identification result as to whether or not the input data is malignant (for example, a probability value that input data is malignant). This identification model is realized, for example, by Domain Profiler (a model that performs binary classification of malignant and benign on domain names by machine learning; see NPL 3), or the like.

The explanation model is a model that receives the input data and the identification model, and outputs the grounds (explanatory result) for the identification of the input data by the identification model. This explanation model is realized by, for example, LIME (see NPL 7), SHAP (see NPL 8), and the like.

The data set is a data set used for learning the identification model. This data set is, for example, data in which data (feature quantity) is associated with true identification label (malignant/benign) of the data.

The control unit 13 controls the determination apparatus 10 as a whole. The control unit 13 is, for example, an electronic circuit such as a central processing unit (CPU) or a micro processing unit (MPU), or an integrated circuit such as an application specific integrated circuit (ASIC) or a field programmable gate array (FPGA). The control unit 13 also has an internal memory for storing programs defining various processing procedures and control data, and executes each processing using the internal memory. Further, the control unit 13 functions as various processing units by various programs being operated.

The control unit 13 includes a learning unit 131, a data reception unit 132, an identification unit 133, a grounds output unit 134, a determination unit 135, an extraction unit 136, and a data output unit 137. A tendency analysis unit 138 and a learning data selection unit 139 may or may not be included, and a case in which the tendency analysis unit 138 and the learning data selection unit 139 are included will be described below.

The learning unit 131 learns the objection determination model. The learning unit 131 learns the objection determination model using, for example, a learning data set including the identification result of the input data output by the identification model, the identification explanation result output by the explanation model, and the label indicating whether or not the identification result is correct.

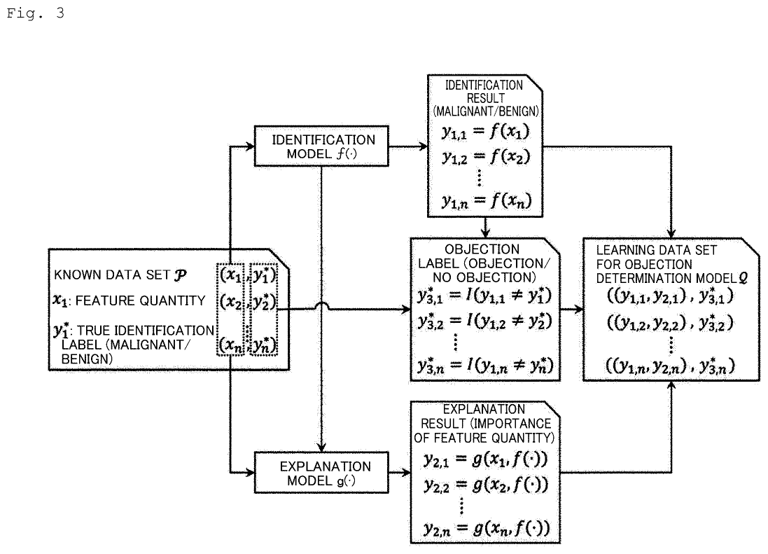

An example of objection determination model learning by the learning unit 131 will be described with reference to FIG. 3. First, a procedure in which the learning unit 131 creates a learning data set Q of the objection determination model will be described.

First, the learning unit 131 prepares a data set P={(Xᵢ, yᵢ*)}, i=1, 2, . . . , n whose true identification label is known. This data set P is, for example, a set of n samples consisting of a set of an m-dimensional feature vector Xᵢ=(X_{i,1}X_{i,1, 2}, . . . , X_{i,m}) characterizing the sample and a true identification label yᵢ* thereof E ∈ {malignant, benign}.

In order to create the learning data set Q, the learning unit 131 inputs xᵢ to the identification model f (·) and the explanation model g (·), and obtains the identification result y_{1,i}=f (xᵢ) ∈ {malignant, benign} and the explanation result Y_{2,1}=g (xᵢ, f (·)). This explanation result _{y2,1} is given as an m-dimensional vector like the feature quantity vector xᵢ. Each element of the explanation result y_{2,i} is, for example, the importance of the feature quantity x_{i,j} corresponding to each element of the feature quantity vector Xᵢ. The importance of this feature quantity x_{i,j} may be a value calculated using any XAI.

Next, the learning unit 131 compares the identification result y_{1,i} with the true identification label yᵢ* to generate an objection label y_{3,i}*=I (y_{1,i}≠yᵢ*). However, I (·) illustrated in FIG. 3 is an indicator function that becomes 1 (there is an objection) when a value inside the parenthesis is true and 0 (there is no objection) when the value is false. That is, the learning unit 131 generates a label “there is an objection (the identification result is incorrect)” when the identification result y_{1,i} of the identification model does not match the true identification label yᵢ*, and “there is no objection (the identification result is correct)” when the identification result matches the true identification label.

Through the above procedure, the learning unit 131 creates a learning data set Q ={(y_{1,i}, y_{2,i}), y_{3,i}}, i=1, 2, . . . , n of the objection determination model.

The learning unit 131 uses the learning data set Q to learn the objection determination model so that the output h (y_{1, i}, y_{2,i}) of the objection determination model for the feature quantity (y_{1,i}, y_{2,i}) matches the objection label y_{3,i}*. Any supervised machine learning algorithm can be used for learning of this objection determination model.

In order to increase the determination accuracy of the objection determination model, the learning unit 131 may also perform learning of the objection determination model using samples having a high likelihood that an objection determination will occur (that is, a high likelihood that false detection or overlooking occurs in the identification result) among the samples included in the learning data set Q. An embodiment in this case will be described in a second embodiment.

The description of FIG. 2 is referred back to. The data reception unit 132 receives input of data (input data) of an identification target by the identification model. The identification unit 133 identifies whether or not the input data is malignant using the identification model. The grounds output unit 134 uses the explanation model to output the grounds (explanation result) of the identification of the input data by the identification model.

The determination unit 135 inputs the identification result output by the identification model and the grounds for the identification output by the explanation model to the learned objection determination model to output a value (determination result) indicating the plausibility of the identification result. The determination result is, for example, the probability that the identification result is incorrect.

The extraction unit 136 extracts data to be verified by the user of the determination apparatus 10 on the basis of the determination result of the determination unit 135. For example, the extraction unit 136 extracts data up to a predetermined rank in descending order of error probability (for example, the identification result, the input data that is an identification target, and the identification explanation result) from the storage unit 12. Also, the extraction unit 136 may extract from the storage unit 12 data whose error probability is greater than or equal to a predetermined threshold. The data output unit 137 outputs the data extracted by the extraction unit 136 via the input and output unit 11.

### Example of Processing Procedure

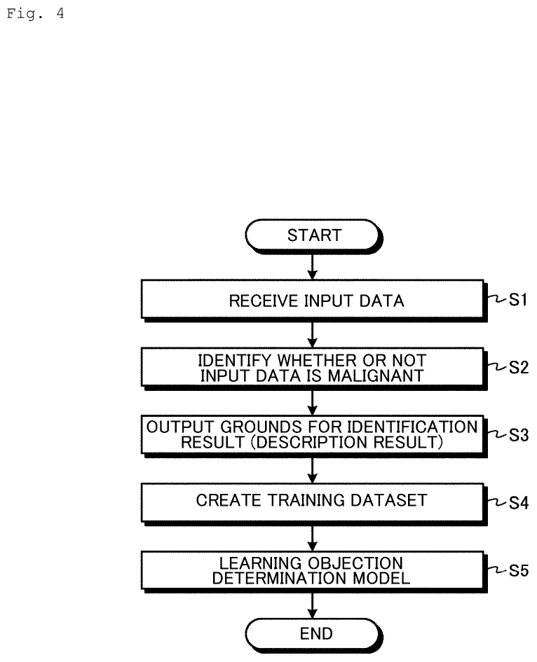

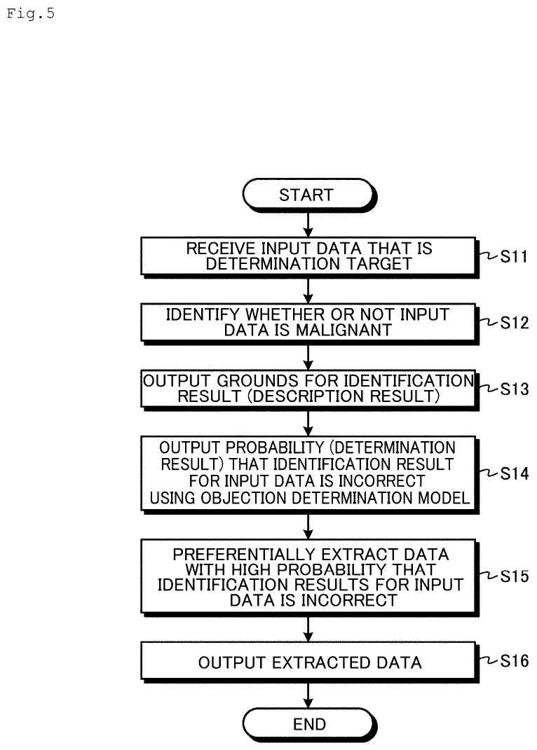

Next, an example of the processing procedure of the determination apparatus 10 will be described with reference to FIGS. 4 and 5. First, a procedure in which the determination apparatus 10 learns the objection determination model will be described with reference to FIG. 4.

The data reception unit 132 of the determination apparatus 10 receives input data (data set) (S1). Next, the identification unit 133 identifies whether or not the input data received in S1 is malignant using the identification model (S2). Further, the grounds output unit 134 uses the explanation model to output the grounds (explanation result) of the identification result (identification result) of S2 (S3).

The learning unit 131 uses the input data identification result obtained through the process of S2, the identification explanation result obtained by the process of S3, and the label indicating whether or not the identification result is correct, to create a training data set for the objection determination model (S4). The learning unit 131 learns the objection determination model using the learning data set created in S4 (S5).

Next, an example of determination processing using the objection determination model will be described with reference to FIG. 5. The data reception unit 132 of the determination apparatus 10 receives input data of a determination target (S11). Next, the identification unit 133 identifies whether or not the input data received in S11 is malignant using the identification model (S12). Thereafter, the grounds output unit 134 uses the explanation model to output the grounds (explanation result) of the identification result (identification result) of S12 (S13).

Thereafter, the determination unit 135 uses the objection determination model to determine whether or not the result of the identification of the input data in the identification model is incorrect. For example, the determination unit 135 inputs the input data identification result of S12 and the explanation result of S13 to the objection determination model, and outputs a probability that the identification result of the input data is incorrect (determination result) (S14).

The extraction unit 136 preferentially extracts data with a high probability that the identification result is incorrect (S15). For example, the extraction unit 136 extracts the input data up to the predetermined rank of the probability that the identification result is incorrect, the identification result, and the identification explanation result. Thereafter, the data output unit 137 outputs the data extracted in S15 (S16).

Through the above processing, the determination apparatus 10 can output data (=data to be verified by a human) for which identification results of the identification model are highly likely to be an error. As a result, a human (for example, an analyst) can efficiently verify the identification result. In addition, it is possible to reduce the labor required when the human verifies the identification result of the identification model.

### Second Embodiment

As described above, the learning unit 131 of the determination apparatus 10 may perform learning of the objection determination model using samples having a high likelihood that the identification result is incorrect (a high likelihood that false detection or overlooking occurs) among the samples included in the learning data set Q in order to increase the determination accuracy of the objection determination model. An embodiment in this case will be described as a second embodiment. The same configurations as in the first embodiment are denoted by the same reference numerals, and description thereof is omitted.

The determination apparatus 10 of the second embodiment further includes the tendency analysis unit 138 and the learning data selection unit 139 illustrated in FIG. 2. The tendency analysis unit 138 analyzes whether the identification model tends to identify malignant input data as non-malignant data (whether the identification model tends to overlook malignancy) or whether the identification model tends to identify non-malignant input data as malignant data (whether there is a tendency for false detection).

For example, the tendency analysis unit 138 compares the identification result obtained by inputting the data set used for the learning of the identification model to the identification model with correct answer label indicating whether or not each piece of data of the data set is malignant, to analyze whether the identification model has any of the above tendencies.

The learning data selection unit 139 selects the range of data used for learning of the objection determination model on the basis of analysis results of the tendency of the identification model in the tendency analysis unit 138.

For example, when the tendency analysis unit 138 analyzes that the identification model “tends to overlook malignancy,” the learning data selection unit 139 selects data identified as non-malignant data even though the data is malignant by the identification model, as the data used for learning of the objection determination model.

On the other hand, when the tendency analysis unit 138 analyzes that the identification model “tends to have many false detection”, the learning data selection unit 139 selects data identified as malignant data even though the data is not malignant by the identification model, as the data used for learning of the objection determination model.

The determination apparatus 10 selects the data to be used for learning of the objection determination model as described above, making it possible to efficiently perform learning of the objection determination model.

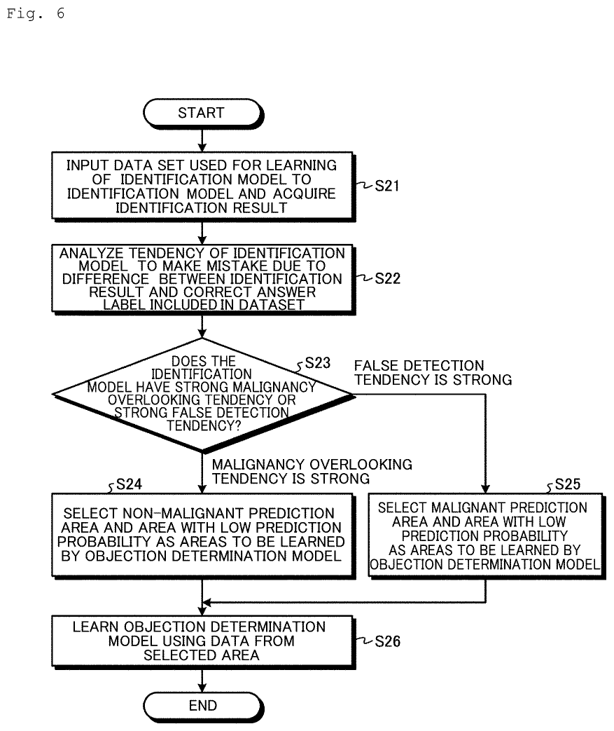

An example of a learning procedure of the objection determination model in the determination apparatus 10 of the second embodiment will be described with reference to FIG. 6. The tendency analysis unit 138 of the determination apparatus 10 inputs the data set used for learning of the identification model to the identification model and acquires the identification result (S21). Thereafter, the tendency analysis unit 138 analyzes the tendency of the identification model to make a mistake (strong malignancy overlooking tendency/high false detection tendency) using a difference between the identification result obtained in S21 and the correct answer label included in the data set (S22).

In S22, when the tendency analysis unit 138 analyzes that the identification model has a strong malignancy overlooking tendency (S23→strong malignancy overlooking tendency), the learning data selection unit 139 selects a non-malignant prediction area and an area with a low prediction probability as areas to be learned by the objection determination model (S24). For example, the learning data selection unit 139 selects a sample whose probability of being identified to be malignant is equal to or less than a predetermined value (for example, 0.1 or more and 0.5 or less) among the samples included in the learning data set Q as a sample to be learned by the objection determination model.

On the other hand, in S22, when the tendency analysis unit 138 analyzes that the identification model has a strong tendency of false detection (S23→strong false detection tendency), the learning data selection unit 139 selects the malignant prediction area and the area with a low prediction probability as areas to be learned by the objection determination model (S25). For example, the learning data selection unit 139 selects a sample whose probability of being identified to be malignant is equal to or less than a predetermined value (for example, 0.5 or more and 0.9 or less) among the samples included in the learning data set Q as a sample to be learned by the objection determination model.

Thereafter, the processing proceeds to S26.

The learning unit 131 learns the objection determination model using the data of the area selected by the learning data selection unit 139 in S24 or S25 (S26).

By doing so, the determination apparatus 10 can efficiently learn the objection determination model on the basis of the characteristics of the identification model.

### Others

The determination apparatus 10 outputs data (=data to be verified by a human) for which the recognition result of the recognition model is doubtful, the human verifies the data, and then, the determination apparatus 10 may re-learn the discriminant model using the result verification of the human. By doing so, the determination apparatus 10 can improve the accuracy of identification of the identification model. As a result, it is possible to further reduce a human effort for verifying the identification result of the identification model.

### Experimental Result

Next, evaluation results of the objection determination model learned by the determination apparatus 10 described in the second embodiment are shown below.

Here, an evaluation result in a case in which the identification model of a determination target of the objection determination model is a model learned by the dataset of Domain Profiler will be described. In this Domain Profiler data set, 80 samples identified as malicious domain names by the identification model were used as test data for the objection determination model. These 80 samples were all identified as malignant domain names by the identification model, but 12 benign domain names are actually included.

Using the above test data, the effectiveness of the objection determination model was evaluated. The objection determination model set a sample whose confidence that the identification result of the identification model is determined to be incorrect (there is an objection) is 0.5 or more, as a sample determined to be “there is an objection” by the objection determination model. Also, a sample whose confidence is less than 0.5 was set as a sample determined to be “there is no objection” by the objection determination model.

Here, when an analyst (human) verified 31 samples determined to be “there is an objection” by the objection determination model, 11 of the samples were correct. That is, a correct answer rate of “there is an objection” is 0.35 (=11/31). Also, when the analyst verified 49 samples determined to be “there is no objection” by the objection determination model, three of the samples were incorrect. That is, the incorrect answer rate of “there is no objection” is 0.06 (=3/49).

Also, evaluation results in a case in which the identification model of a determination target in the objection determination model is a model learned from a data set of Endgame Malware Benchmark for Research (EMBER) will be described. In this EMBER data set, 81 samples identified as benign PE files (benign portable executable files) by the identification model were used as test data for the objection determination model.

These 81 samples were all identified as benign PE files by the identification model, but 18 malignant PE files are actually included among the samples.

Using the above test data, the effectiveness of the objection determination model was evaluated. Here, the objection determination model also set a sample whose confidence that the identification result of the identification model is determined to be incorrect (there is an objection) is 0.5 or more, as a sample determined to be “(there is an objection)” by the objection determination model. Also, the sample whose confidence is less than 0.5 was set as a sample determined to be “there is no objection” by the objection determination model.

Here, when an analyst verified 52 samples determined to be “there is an objection” using the objection determination model, 15 samples among the samples were correct answers. That is, the correct answer rate of “there is an objection” is 0.28 (=15/52). In addition, when an analyst verified 29 samples determined to be “there is no objection” using the objection determination model, three samples among the samples were incorrect answers. That is, the incorrect answer rate of “there is no objection” is 0.10 (=3/29).

From the above, it was confirmed that the samples determined to have objections by the objection determination model (the identification result of the identification model is highly likely to be incorrect) were samples good for verification target by the human.

### System Configuration, or Like

Also, each component of each unit illustrated in the figure is functionally conceptual, and does not necessarily need to be physically configured as illustrated in the figure. That is, a specific form of distribution and integration of each apparatus is not limited to the illustrated one, and all or part thereof can be functionally or physically distributed and integrated in arbitrary units according to various loads or usage situations and configured. Further, all or some of respective processing functions performed by respective apparatuses can be realized by a CPU and a program executed by the CPU, or realized as hardware by wired logic.

Further, among the processing described in the above embodiments, all or some of the processing described as being performed automatically can be performed manually, or all or some of the processing described as being performed manually can be performed automatically by using a known method. In addition, information including processing procedures, control procedures, specific names, and various types of data or parameters illustrated in the literatures or drawings can be arbitrarily changed unless otherwise specified.

### Program

The determination apparatus 10 described above can be implemented by installing a program (determination program) as package software or online software in a desired computer. For example, the information processing device is caused to execute the above program so that the information processing device functions as the determination apparatus 10. The information processing apparatus referred to here includes a mobile communication terminal such as a smart phone, a mobile phone, and a personal handyphone system (PHS), or a terminal such as a personal digital assistant (PDA).

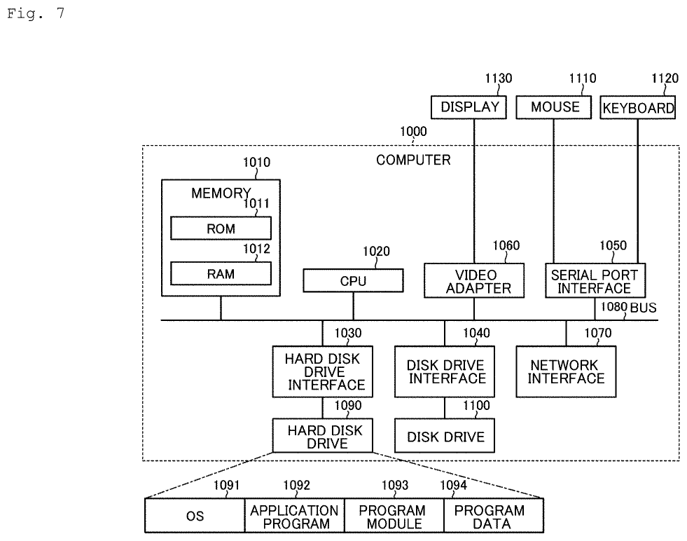

FIG. 7 is a diagram illustrating an example of a computer that executes a determination program. A computer 1000 includes a memory 1010 and a CPU 1020, for example. The computer 1000 also includes hard disk drive interface 1030, a disk drive interface 1040, a serial port interface 1050, a video adapter 1060, and a network interface 1070. These units are connected by a bus 1080.

The memory 1010 includes a read only memory (ROM) 1011 and a random access memory (RAM) 1012. The ROM 1011 stores a boot program such as a basic input output system (BIOS), for example. The hard disk drive interface 1030 is connected to a hard disk drive 1090. The disk drive interface 1040 is connected to a disk drive 1100. A removable storage medium such as a magnetic disk or optical disc is inserted into the disk drive 1100. The serial port interface 1050 is connected to a mouse 1110 and a keyboard 1120, for example. The video adapter 1060 is connected to a display 1130, for example.

The hard disk drive 1090 stores an OS 1091, an application program 1092, a program module 1093, and program data 1094, for example, That is, a program that defines each processing to be executed by the determination apparatus 10 is implemented as the program module 1093 in which computer-executable code is described. The program module 1093 is stored, for example, in the hard disk drive 1090. For example, the program module 1093 for executing the same processing as in the functional configuration in the determination apparatus 10 is stored in the hard disk drive 1090. The hard disk drive 1090 may be replaced by a solid state drive (SSD).

Data used in the processing of the above-described embodiments is stored as the program data 1094 in the memory 1010 or the hard disk drive 1090, for example. The CPU 1020 reads the program module 1093 or the program data 1094 stored in the memory 1010 or the hard disk drive 1090 to the RAM 1012 and executes the program data, as necessary.

The program module 1093 or the program data 1094 is not limited to a case in which the program module 1093 or the program data 1094 is stored in the hard disk drive 1090, and may be stored in a removable storage medium, for example, and read by CPU 1020 via the disk drive 1100 or the like. Alternatively, the program module 1093 and the program data 1094 may be stored in another computer connected via a network (a local area network (LAN), a wide area network (WAN), or the like). The program module 1093 and the program data 1094 may be read by CPU 1020 through the network interface 1070 from the other computer.

### REFERENCE SIGNS LIST

10 Determination apparatus
11 Input and output unit
12 Storage unit
13 Control unit
131 Learning unit
132 Data reception unit
133 Identification unit
134 Grounds output unit
135 Determination unit
136 Extraction unit
137 Data output unit
138 Tendency analysis unit
139 Learning data selection unit

1. A determination apparatus, comprising:
identification circuitry configured to identify whether or not input data is malignant using an identification model for identifying whether or not the input data is malignant;
grounds output circuitry configured to output grounds for identification of the input data in the identification model using an explanation model for outputting grounds for identification using the identification model; and
determination circuitry configured to input a result of the identification and the grounds for the identification to an objection determination model, the objection determination model receiving the result of the identification and the grounds for the identification and outputting a probability that the result of the identification is incorrect, to output the probability that the result of the identification is incorrect.

2. The determination apparatus according to claim 1, further comprising:
learning circuitry configured to perform learning of the objection determination model using a data set including the result of the identification and the grounds for the identification, and a label indicating whether the result of the identification is correct.

3. The determination apparatus according to claim 2, wherein:
the learning circuitry learns the objection determination model using data identified as non-malignant data by the identification model even though the data is malignant among data in the data set when the identification model tends to identify the malignant data as non-malignant data.

4. The determination apparatus according to claim 2, wherein:
the learning circuitry learns the objection determination model using data identified as malignant data by the identification model even though the data is not malignant data among the data in the data set when the identification model tends to identify non-malignant data as malignant data.

5. The determination apparatus according to claim 3, further comprising:
tendency analysis circuitry configured to analyze whether the identification model tends to identify malignant input data as non-malignant data or whether the identification model tends to identify non-malignant input data as malignant data, on the basis of an identification result obtained by inputting the data used for learning of the identification model to the identification model and a correct answer label indicating whether or not the data is malignant.

6. The determination apparatus according to claim 1, further comprising:
extraction circuitry configured to extract data to be verified by a user on the basis of a probability that the identification result is incorrect.

7. A determination method, comprising:
identifying whether or not the input data is malignant using an identification model for identifying whether or not the input data is malignant;
outputting grounds for identification of the input data in the identification model using an explanation model for outputting grounds for identification using the identification model; and
inputting a result of the identification and the grounds for the identification to an objection determination model, the objection determination model receiving the result of the identification and the grounds for the identification and outputting a probability that the result of the identification is incorrect, to output the probability that the result of the identification is incorrect.

8. A non-transitory computer readable medium storing a determination program for causing a computer to execute:
identifying whether or not the input data is malignant using an identification model for identifying whether or not the input data is malignant;
outputting grounds for identification of the input data in the identification model using an explanation model for outputting grounds for identification using the identification model; and
inputting a result of the identification and the grounds for the identification to an objection determination model, the objection determination model receiving the result of the identification and the grounds for the identification and outputting a probability that the result of the identification is incorrect, to output the probability that the result of the identification is incorrect.
